(19) United States
(12) Patent Application Publication
(10) Pub. No.: US 2025/0127156 A1
(43) Pub. Date: Apr. 24, 2025

(54) METHOD FOR APPLYING AT LEAST ONE SPRAY PRODUCT TO AGRICULTURAL LAND

(71) Applicant: Robert Bosch GmbH, Stuttgart (DE)

(72) Inventors: Hans-Arndt Freudigmann, Tuebingen (DE); Johanna Link-Dolezal, Denkendorf (DE)

(21) Appl. No.: 18/682,219

(22) PCT Filed: Aug. 5, 2022
(86) PCT No.: PCT/EP2022/072086

§ 371 Date: Feb. 8, 2024

(30) Foreign Application Priority Data
Sep. 22, 2021 (DE) 10 2021 210 510.6

(51) Int. Cl. A01M 7/00; G06V 20/10

(52) U.S. Cl. CPC A01M 7/0089; G06V 20/188

(57) ABSTRACT

A method for applying at least one spray product to agricultural land having crop plants and weeds. The crop plants and weeds can be assigned to a cotyledon class of monocotyledons or to a cotyledon class of dicotyledons. The at least one spray product is applied to the acquired field section of the agricultural land by means of at least one spray nozzle unit of an agricultural spraying device depending on the cotyledon class of the crop plants and a first ascertained weed identification number and/or a second ascertained weed identification number.

### FIELD

The present invention relates to a method for applying at least one spray product to agricultural land comprising crop plants and weeds by means of at least one spray nozzle unit of an agricultural spraying device, wherein the crop plants and weeds can be assigned to a cotyledon class of monocotyledons or to a cotyledon class of dicotyledons, and to a control unit and an agricultural spraying device for applying at least one spray product according to the cotyledon class.

### BACKGROUND INFORMATION

The agricultural plant protection measures (spraying process) of today involve applying the spray mixture consisting of plant protection agents, growth regulators or liquid fertilizers and a carrier liquid over the entire surface of a field to be treated. With this type of full-surface application, there is no way to react to the condition of the field and to the actual local need for plant protection agents and carrier liquid.

Modern plant protection devices have the technical capabilities to apply spray mixture in a site-specific manner. These technical capabilities include the ability to switch individual nozzles or sections on and off and also the ability to couple the nozzle or section control to an application map or a suitable sensor system. Such a sensor system can be a weed sensor, for instance.

In contrast to a full-surface application, in a site-specific application not all areas of the field are treated with the target application rate. Due to the process involved, the challenge with this application method is that the partial areas to be treated have to be identified prior to the application. As mentioned above, weed sensors can be used for this purpose, for instance. The weeds are typically always treated in the same manner, regardless of the species, size, and other features.

With regard to weed composition, a basic distinction is made between 2 classes of plants: grasses (monocotyledons) and weeds (dicotyledons) that differ in terms of morphology and physiology (absorption of the active agent, transport to the site of action, metabolism/activation of the active agent, site of action of herbicides). Therefore different selective herbicides are suitable for effective treatment depending on the weed class and species. Whether a treatment of the respective weed species is carried out today depends primarily on the so-called economic damage threshold.

Crop plants can likewise can be assigned to the two classes of plants (e.g. monocotyledonous crop plant=grain, dicotyledonous crop plant=sugar beet). This means that a monocotyledonous crop plant is also negatively affected by grass herbicides; as is a dicotyledonous crop plant by weed herbicides. This negative effect of herbicides on the crop plant (phytotoxicity) is sought to be circumvented by timing (before sowing or before the crop plant emerges) and location (depth of application of the herbicide), as well as by the addition of so-called safeners. These measures are limited, however, so that the treatment of grasses in monocotyledonous crop plants and weeds in dicotyledonous crop plants is generally more difficult (the risk of phytotoxicity is greater or the effectiveness of the measure is reduced). This means that certain weed compositions can be treated more easily/more effectively in one crop than in another crop.

An object of the present invention is to adapt the application strategy of the partial area application depending on the respective crop plant. It is in particular an object of the present invention to not only use the economic damage threshold as the basis for the application decision, but much more the prospect of a high effectiveness of the application. This makes it possible to improve the treatment success of a selective application.

German Patent Application No. DE 10 2017 210 804 A1 describes a method for applying a spray product to a field, wherein the spray product is applied depending on a degree of coverage of an evaluation area.

### SUMMARY

The present invention relates to a method for applying at least one spray product to agricultural land comprising crop plants and weeds by means of at least one spray nozzle unit of an agricultural spraying device, wherein the crop plants and weeds can be assigned to a cotyledon class of monocotyledons or to a cotyledon class of dicotyledons. According to an example embodiment of the present invention, the method includes the steps:
providing or ascertaining the cotyledon class of the crop plants;
acquiring a field section of the agricultural land by means of an optical acquisition unit of the agricultural spraying device in order to obtain image information;
identifying the weeds in the acquired field section by means of the control unit using the image information in order to assign them to one of the two cotyledon classes;
ascertaining a first weed identification number for the weeds assigned to the monocotyledons and a second weed identification number for the weeds assigned to the dicotyledons by means of the control unit;
applying the at least one spray product depending on
   the cotyledon class of the crop plants and
   the first ascertained weed identification number and/or the second ascertained weed identification number
      to the acquired field section of the agricultural land by means of the at least one spray nozzle unit of the agricultural spraying device.

The present invention also related to a control unit. According to an example embodiment of the present invention, the control unit is configured to carry out and/or control the following steps:
receiving or ascertaining a cotyledon class of crop plants, wherein the crop plants can be assigned to a cotyledon class of monocotyledons or a cotyledon class of dicotyledons;
identifying weeds in image information of a field section of agricultural land acquired by means of an optical acquisition unit in order to assign each one to a cotyledon class of monocotyledons or a cotyledon class of dicotyledons;
ascertaining a first weed identification number for the weeds assigned to the monocotyledons and a second weed identification number for the weeds assigned to the dicotyledons;
outputting a control signal depending on
   the cotyledon class of the crop plants and
   the first ascertained weed identification number and/or the second ascertained weed identification number
      in order to apply at least one spray product to the acquired field section of the agricultural land by means of at least one spray nozzle unit of the agricultural spraying device.

The present invention furthermore relates to an agricultural spraying device for applying at least one spray product to agricultural land comprising crop plants and weeds, comprising at least one spray nozzle unit, at least one optical acquisition unit and an above-described control unit according the present invention.

The present invention also relates to a computer program which is configured to carry out and/or control the steps of an above-described method of the present invention and/or an above-described control unit when the computer program is executed on a computer, and a machine-readable storage medium on which the computer program is stored.

The method according to the present invention provides a site-specific application strategy for at least one spray product that is optimized in terms of effectiveness and adapted to the combination of crop plants and weeds present. A features of the present invention is comparing the crop plant class with the occurring weed classes and deriving the application strategy based on this. The background is that monocotyledonous weeds can be treated more easily or more effectively in dicotyledonous crop plants and, conversely, dicotyledonous weeds can be treated more easily or more effectively in monocotyledonous crop plants.

The method of the present invention is intended for, but not limited to, agricultural purposes. In the context of the present invention, an agricultural purpose can be understood to mean a purpose directed to economic cultivation of crop plants.

The at least one spray product is applied to agricultural land or an area used for agriculture. This can be understood to mean a field or a plant cultivation area or also a parcel of such a cultivation area. The agricultural land can thus be arable land, a grassland or a pasture.

The plants can include crop plants, for example, i.e. crops, the fruit of which is used agriculturally (for example as food, feed or as an energy crop), as well as weeds, i.e. weeds and grass weeds. Both the crop plants and the weeds can be assigned to either a cotyledon class of monocotyledons or a cotyledon class of dicotyledons.

All steps of the method are preferably carried out during a movement, in particular a travel or flight of the agricultural spraying device over the agricultural land.

According to an example embodiment of the present invention, the agricultural spraying device is advantageously configured to carry out the method in an automated and/or autonomous manner in order to enable quick, reliable and efficient treatment of the agricultural land.

According to an example embodiment of the present invention, the agricultural spraying device can in particular be part of an agricultural field sprayer or plant protection device, or can be configured as an agricultural field sprayer or plant protection device. The agricultural spraying device can comprise a mobile unit or can be disposed on a mobile unit, wherein the mobile unit can in particular be configured as a land vehicle and/or an aircraft and/or a trailer. The mobile unit can in particular be an agricultural work machine, for example a towing vehicle, a tractor, a self-driving or autonomous field sprayer, or a self-driving or autonomous robot. The agricultural spraying device can in particular be a towed field sprayer, a self-driving field sprayer, or a mounted field sprayer. The agricultural spraying device can also be mounted on a hydraulic device of an agricultural work machine. It is also possible that the agricultural spraying device is mounted on a loading area of an agricultural work machine. Alternatively, the spraying device can be hitched to the agricultural work machine. The agricultural spraying device or the field sprayer can comprise at least one spray product tank for holding the spray product. The agricultural spraying device or the field sprayer can also comprise a mixing unit, which mixes (blends) a spray product concentrate with water directly on the agricultural spraying device to form the spray product to be applied. The agricultural sprayer or field sprayer can comprise a respective spray product tank for water and various spray products or spray product concentrates and mix the spray to be applied via the mixing unit and apply it via the same or different spray product line systems of the agricultural spraying device.

According to an example embodiment of the present invention, the at least one spray product is in particular a spray liquid. The spray product can comprise or be an agricultural preparation or plant protection agent (PPA), in particular a plant protection agent concentrate. The spray product can therefore comprise a pesticide, such as an herbicide, a fungicide or an insecticide. The spray product can also comprise a fertilizer, in particular a fertilizer concentrate. The spray product can comprise a growth regulator. The spray product can comprise a granular active agent which has been mixed with a carrier liquid. The spray liquid can, for example, be a: liquid, suspension, emulsion, solution or a combination thereof. The spray liquid is preferably a plant protection agent diluted with water or a fertilizer diluted with water. The spray liquid can therefore be a spray mixture, for instance.

According to an example embodiment of the present invention, the spray nozzle unit preferably comprises at least one spray nozzle for applying the spray product and at least one valve for controlling or regulating the applied quantity of spray product. The spray nozzle unit is therefore configured such that it can be controlled or actuated. The valve can be disposed or integrated in the spray nozzle. The valve can, however, also be connected upstream of the spray nozzle, i.e., disposed upstream of the spray nozzle (in the direction of flow of the spray product). However, the spray nozzle unit can also comprise multiple spray nozzles which each have an upstream valve. The spray nozzle unit can furthermore also comprise multiple spray nozzles with only one valve upstream of the spray nozzles, so that, when the valve is actuated, the spray product is applied using all of the spray nozzles of the spray nozzle unit. The valve can be configured as a pulse-width modulated (PWM) valve or as a proportional valve. The spray nozzle unit can be configured as a section of a nozzle system of the agricultural spraying device. The spray nozzle units can be actuated individually or separately and/or in defined groups or associations and/or all together. The spray nozzles of each spray nozzle unit can be actuated individually or separately and/or in defined groups or associations and/or all together. The spray nozzle unit can also comprise different spray nozzles for applying various spray products.

According to an example embodiment of the present invention, each row of field sections (=field sections along the direction of movement or travel) can be assigned one or more spray nozzle unit(s) or spray nozzle(s) of a spray nozzle unit. Each row of field sections can be assigned exactly one spray nozzle unit or spray nozzle of a spray nozzle unit, for instance, or exactly two spray nozzle units or spray nozzles of a spray nozzle unit, in order to be treated.

According to an example embodiment of the present invention, the application of the spray product can in particular be carried out using a delivery unit. The delivery unit can be configured to deliver or conduct, in particular meter, a liquid and/or a granulate under pressure. The delivery unit can therefore, for example, comprise one or more pumps, feed pumps, metering pumps, pressure accumulators, screw conveyors, valves, apertures, etc.

According to an example embodiment of the present invention, the optical acquisition unit is preferably disposed on the agricultural spraying device. The optical acquisition unit can comprise at least one, preferably a plurality of cameras. The cameras can be selected from the group consisting of: multispectral camera and/or hyperspectral camera and/or infrared camera and/or camera and/or 3D camera. The optical acquisition unit can be configured to acquire or record images in the NIR and/or visual range. The optical acquisition unit can comprise a light or illumination unit. The optical acquisition units can be configured to communicate with one another. However, the optical acquisition units preferably operate autonomously, i.e. independently of one another. Each row of field sections can be assigned an optical acquisition unit. However, it is also possible that one optical acquisition unit acquires two or more rows of field sections.

The spray nozzle unit or the spray nozzles and the optical acquisition unit or the cameras are preferably disposed on a spray boom of the agricultural spraying device.

The image information is preferably an image or map of the acquired field section or a portion of an acquired field section. Taken together, multiple pieces of image information can therefore represent the entire field section, for example by lining up and/or overlapping and/or stitching.

In the context of the present application, “providing” can include processing and/or inputting and/or transmitting and/or receiving information by wire or wirelessly. The cotyledon class of the crop plants can thus be entered or received manually, for instance. Alternatively, the cotyledon class of the crop plants can also be ascertained using the obtained image information.

According to an example embodiment of the present invention, the step of identifying weeds can include acquiring a color component, in particular a green color component and/or an infrared component, in the field section or portion of the image. Plants can be detected using the optical acquisition unit, e.g., based on a specified NDVI value (normalized difference vegetation index, which is formed from reflection values in the near infrared and visible red wavelength range of the light spectrum) by distinguishing biomass or vital plants and plant parts from the ground. An identification of plants can thus be carried out, for example by recognizing green pixels or contiguous green pixels in the image information.

According to an example embodiment of the present invention, in the step of identifying, preferably all plants, i.e., also the crop plants in the entire acquired field section or the overall image information, are identified. Using the identified plants, rows of crop plants, for instance, can then be identified in the field section or image information. Further preferably, in accordance with German Patent Application No. DE 10 2017 210 804 A1, crop plant areas are defined, wherein identified plants in the crop plant areas are considered by definition to be crop plants; weed areas are defined as well, wherein identified plants in the weed areas are considered by definition to be weeds.

According to an example embodiment of the present invention, the assignment is a classification of the identified weeds into one of the two cotyledon classes by means of the control unit.

According to an example embodiment of the present invention, after the assignment, a first weed identification number for the weeds assigned to the monocotyledons and a second weed identification number for the weeds assigned to the dicotyledons is ascertained by means of the control unit. The weed identification numbers preferably represent a number of the respective weeds or a degree of coverage of the acquired field section of plant material of the respective weeds or a quantity of plant material of the respective weeds.

According to an example embodiment of the present invention, a step of providing or ascertaining a first application threshold value for the first weed identification number and a second application threshold value for the second weed identification number depending on the cotyledon class of the crop plants is preferably provided here, wherein, in the step of applying, the at least one spray product is further applied depending on the first application threshold value and/or the second application threshold value.

According to an example embodiment of the present invention, the first application threshold value for the first weed identification number is preferably greater than the second application threshold value for the second weed identification number if the crop plants are assigned to the monocotyledons. Alternatively or additionally, the second application threshold value for the second weed identification number is preferably greater than the first application threshold value for the first weed identification number if the crop plants are assigned to the dicotyledons. In other words, this means that the respective application threshold value is greater if the cotyledon class of the weeds corresponds to the cotyledon class of the crop plants. Thus, if monocotyledonous crop plants are growing on the agricultural land, the first application threshold value for the weeds of the same cotyledon class, i.e. for the monocotyledonous weeds (=first weed identification number) is greater, and vice versa.

According to an example embodiment of the present invention, the second application threshold value for the second weed identification number is preferably selected such that the at least one spray product or at least one of the spray products is applied if the crop plants are assigned to the monocotyledons and at least one of the identified weeds is assigned to the dicotyledons. Alternatively or additionally, the first application threshold value for the first weed identification number is preferably selected such that the at least one spray product or at least one of the spray products is applied if the crop plants are assigned to the dicotyledons and at least one of the identified weeds is assigned to the monocotyledons. In other words, this means that, when a single respective weed is identified or assigned, the spray product is applied accordingly, so that, in this respect, a zero tolerance strategy is used. For the application threshold value of the other cotyledon class, on the other hand, a more moderate strategy is used, e.g. in accordance with the economic damage threshold.

According to an example embodiment of the present invention, in the step of applying, the at least one spray product or at least one of the spray products is applied to the acquired field section of the agricultural land by means of the at least one spray nozzle unit of the agricultural spraying device depending on the cotyledon class of the crop plants and the first ascertained weed identification number and/or the second ascertained weed identification number. In the context of the present invention, for a plurality of spray products, the term “the at least one spray product” includes all spray products or at least one of the spray products, as the case may be.

According to an example embodiment of the present invention, in the step of applying, the first weed identification number is preferably compared here to the first application threshold value and/or the second weed identification number is compared to the second application threshold value by means of the control unit, wherein the at least one spray product is applied when the first application threshold value or the second application threshold value is reached, undershot or exceeded. The control unit is preferably used to ascertain whether and/or how much and/or which of the at least one spray product is applied.

Thus, the cotyledon class of the crop plant, for instance, can first be derived from the crop plant to be treated. A respective application threshold value for the treatment worthiness of the cotyledon classes of the weeds can then be ascertained in accordance with this cotyledon class. This differs for the two cotyledon classes (monocotyledons, dicotyledons). Taking into consideration the phytotoxicity and effectiveness of the measure, a common first application threshold value (e.g. economic damage threshold) is then set for treatment for monocotyledonous weeds in a monocotyledonous crop plant, for example, while a second “zero tolerance” application threshold value is set for dicotyledons in the monocotyledonous crop plant (and vice versa for dicotyledonous crop plants). The respective application threshold value is stored in the algorithm for the application strategy. The information about the actual weed identification number or weed population flows into the application strategy algorithm via the optical acquisition unit. If a weed population exceeds the first or second application threshold value defined for the cotyledon class, the corresponding spray product(s) is/are applied.

Further preferably, according to an example embodiment of the present invention, two spray products are applied, wherein a first spray product is applied depending on the first ascertained weed identification number and/or a second spray product different from the first is applied depending on the second ascertained weed identification number. In this case, the spray products can be provided premixed in separate spray product tanks of the agricultural spraying device or mixed as needed in the step of applying by means of a mixing unit of the agricultural spraying device.

According to an example embodiment of the present invention, the spray product is furthermore preferably applied substantially evenly. In the context of the present invention, even application can be understood to mean application with the same or a constant predefined application quantity per surface area. A predefined application quantity can be understood to be an application quantity that is set in advance or at the beginning of the treatment. The defined application quantity can be preset or entered in advance.

The method or the method steps are of course carried out repeatedly or cyclically. The steps of acquiring the field sections are preferably carried out or carried out repeatedly in a defined, in particular fixed, time interval or in a time interval adapted to the driving speed of the agricultural spraying device. In other words, this means that the field sections are acquired with a defined or a speed-dependent repetition rate.

According to an example embodiment of the present invention, the control unit can comprise a plurality of subordinate control units. The control unit and/or each subordinate control unit can comprise a computing unit or a plurality of computing units for processing signals or data, at least one memory unit for storing signals or data, at least one communication interface for reading in data, in particular for receiving image information, and outputting data, in particular control signals, to a unit, in particular an actuator. Each optical acquisition unit can be assigned to a control unit or subordinate control unit and/or a computing unit, or each optical acquisition unit can comprise its own control unit or subordinate control unit and/or a computing unit. The optical acquisition units can comprise their own subordinate control unit and operate autonomously, for instance, wherein respective data are transmitted to the (higher-level) control unit that makes the second “spray decision” and controls the spray nozzle units assigned to the adjacent field evaluation regions accordingly.

According to an example embodiment of the present invention, the computing unit(s) is/are configured or set up for image processing, so that it/they can carry out calculation steps or image processing steps to implement the method according to the present invention. Each computing unit accordingly comprises corresponding image processing software. The computing unit can be a signal processor, a microcontroller or the like, for example, and the memory unit can be a flash memory, an EPROM or a magnetic memory unit. The communication interface can be configured to read in or output data wirelessly and/or by wire, wherein a communication interface capable of reading in or outputting data transmitted by wire can read said data, for example electrically or optically, from a respective data transmission line or output the data to a respective data transmission line.

The method according to the present invention can accordingly be implemented in software or hardware, for instance, or in a mixed form of software and hardware, in the control unit or a control device.

The control unit can be disposed entirely or partially on or integrated into the agricultural spraying device. However, the control unit can also be entirely or partially external, for example integrated in a cloud.

### BRIEF DESCRIPTION OF THE DRAWINGS

The present invention will be explained in more detail in the following as an example with reference to the figures.

FIG. 1 shows a schematic illustration of an agricultural spraying device, according to an example embodiment of the present invention.

FIG. 2 shows a schematic illustration of monocotyledonous and dicotyledonous weeds in a monocotyledonous crop plant, according to an example embodiment of the present invention.

FIG. 3 shows a corresponding application strategy for a dicotyledonous crop plant, according to an example embodiment of the present invention.

FIG. 4 shows a flowchart of a method according to an example embodiment of the present invention.

### DETAILED DESCRIPTION OF EXAMPLE EMBODIMENTS

In the following description of preferred embodiment examples of the present invention, the same or similar reference signs are used for the elements which are shown in the various figures and have a similar effect, and a repeated description of these elements is omitted.

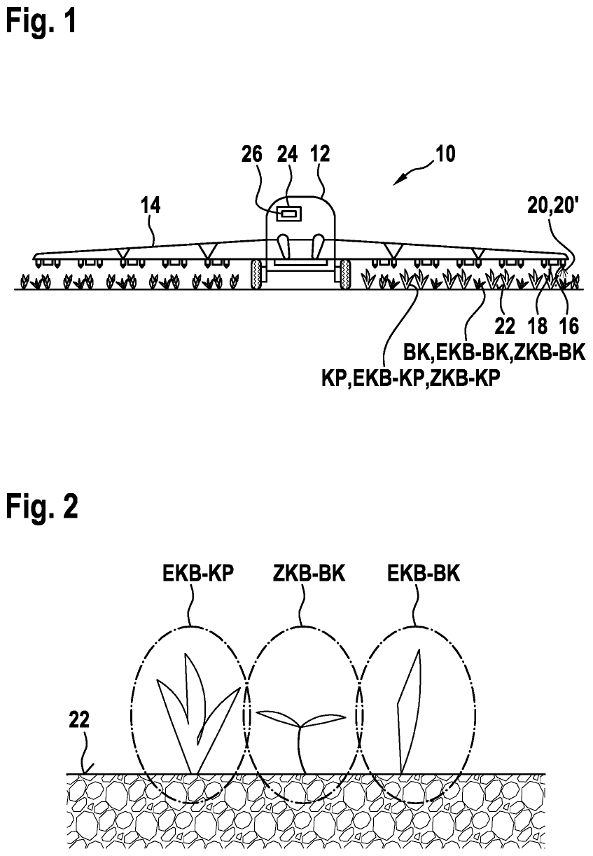

FIG. 1 shows a schematic illustration of an agricultural spraying device, which is labeled as a whole with the reference sign 10.

The agricultural spraying device 10 is configured as a field sprayer 10. The field sprayer 10 is disposed on a mobile land vehicle 12, which is configured as a towing vehicle 12 or tractor 12.

The agricultural spraying device 10 comprises a spray boom 14. Spray nozzle units 16 and optical acquisition units 18 are disposed on the spray boom 14. The spray nozzle units 16 are configured to apply a spray product 20, 20′ to crop plants KP or weeds BK on agricultural land 22. The optical acquisition units 18 are configured as optical cameras 18. The optical cameras 18 each comprise a filter unit to extract a color component, for example the green color component, of an obtained or acquired item of image information or an acquired image in order to acquire a field section of the agricultural land 22 comprising the crop plants KP and weeds BK.

The crop plants KP can be assigned to either a cotyledon class of monocotyledons EKB-KP or a cotyledon class of dicotyledons ZKB-KP. The weeds BK can analogously be assigned to either a cotyledon class of monocotyledons EKB-BK or a cotyledon class of dicotyledons ZKB-BK.

The agricultural spraying device 10 further comprises a (not depicted) delivery unit, by means of which the application quantity or the active agent quantity in the spray product 20, 20′ to be applied can be set or varied.

The agricultural spraying device 10 also comprises a control unit 24, which is connected to the optical cameras 18 to receive information from them. The control unit 24 comprises a computing unit 26, which is configured to carry out calculation steps or image processing steps to implement the method according to the present invention. The control unit 24 is further configured to output a control signal in such a way that the spray product 20, 20′ is applied to the acquired field section of the agricultural land 22 depending on the cotyledon class EKB-KP, ZKB-KP of the crop plants KP and a first weed identification number for the weeds BK assigned to the monocotyledons EKB-BK and a second weed identification number for the weeds BK assigned to the dicotyledons ZK-BK.

FIG. 2. shows a schematic illustration of monocotyledonous and dicotyledonous weeds EKB-BK, ZKB-BK in a monocotyledonous crop plant EKB-KP.

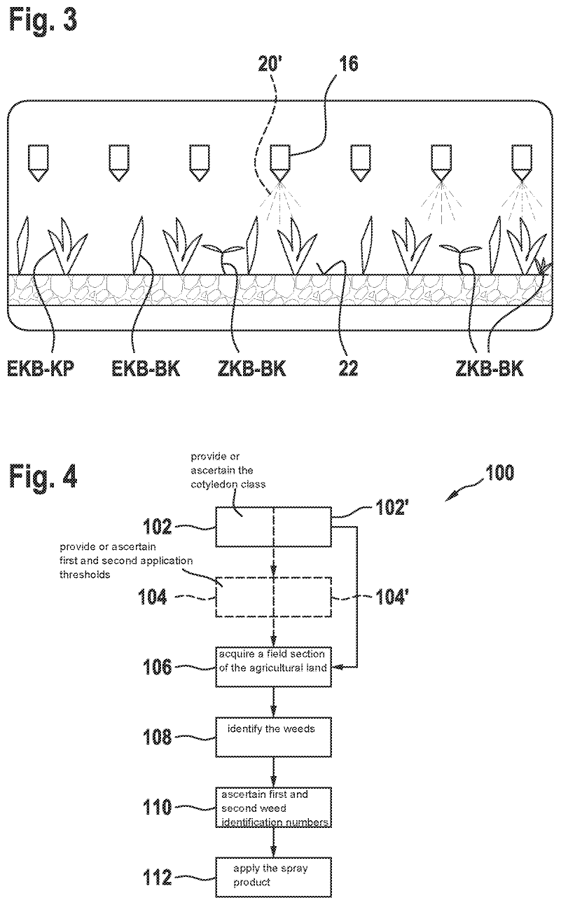

To illustrate the method and/or the application strategy, FIG. 3 shows a field section of the agricultural land 22 comprising monocotyledonous crop plants EKB-KP as well as monocotyledonous weeds EKB-BK and dicotyledonous weeds ZKB-BK. First, the crop plant KP to be treated is ascertained or defined and the cotyledon class of the crop plant EKB-KP is derived from this. The first application threshold value for the first weed identification number of the monocotyledonous weeds EKB-BK and a second application threshold value for the second weed identification number of the dicotyledonous weeds ZKB-BK are then provided or specified according to this cotyledon class EKB-KP. Said value differs for the two cotyledon classes (EKB, ZKB). Taking into consideration the phytotoxicity and effectiveness of the measure, a common first application threshold value (e.g. economic damage threshold) is then set for treatment for the monocotyledonous weeds EKB-BK in the monocotyledonous crop plant EKB-KP, whereas for the dicotyledonous weeds ZKB-BK, on the other hand, a second “zero tolerance” application threshold value is set. Therefore, if even a single dicotyledonous weed ZKB-BK is identified, the spray product 20′ is applied to the partial area.

FIG. 4 shows a flowchart of a method 100 for applying at least one spray product 20, 20′ to agricultural land 24 comprising crop plants KP and weeds BK by means of at least one spray nozzle unit 16 of an agricultural spraying device 10, wherein the crop plants KP and weeds BK can be assigned to a cotyledon class of monocotyledons EKB-KP, EKB-BK or to a cotyledon class of dicotyledons ZKB-KP, ZKB-BK. The method 100 comprises a step of providing 102 or ascertaining 102′ the cotyledon class EKB-KP, ZKB-KP of the crop plants KP. The method 100 further comprises a step of acquiring 106 a field section of the agricultural land 22 by means of an optical acquisition unit 18 of the agricultural spraying device 10 in order to obtain image information. The method 100 also comprises a step of identifying 108 the weeds BK in the acquired field section by means of the control unit 24 using the image information in order to assign them to one of the two cotyledon classes EKB-BK, ZKB-BK. The method 100 also comprises a step of ascertaining 110 a first weed identification number for the weeds BK assigned to the monocotyledons EKB-BK and a second weed identification number for the weeds BK assigned to the dicotyledons ZK-BK by means of the control unit 24. The method 100 further comprises a step of applying 112 the at least one spray product 20, 20′ to the acquired field section of the agricultural land 22 by means of the at least one spray nozzle unit 16 of the agricultural spraying device 10 depending on the cotyledon class EKB-KP, ZKB-KP of the crop plants KP and the first ascertained weed identification number and/or the second ascertained weed identification number.

The method 100 also comprises an optional step of providing 104 or ascertaining 104′ a first application threshold value for the first weed identification number and a second application threshold value for the second weed identification number depending on the cotyledon class EKB-KP, ZKB-KP of the crop plants KP, wherein, in the step of applying 112, the at least one spray product 20, 20′ is further applied depending on the first application threshold value and/or the second application threshold value.

If an embodiment example comprises an “and/or” conjunction between a first feature and a second feature, this is to be read to mean that the embodiment example comprises both the first feature and the second feature according to one embodiment, and either only the first feature or only the second feature according to another embodiment.

1-13. (canceled)

14. A method for applying at least one spray product to agricultural land having crop plants and weeds, using at least one spray nozzle unit of an agricultural spraying device, wherein the crop plants and the weeds can be assigned to a cotyledon class of monocotyledons or to a cotyledon class of dicotyledons, the method comprising the following steps:
providing or ascertaining a cotyledon class of the crop plants;
acquiring a field section of the agricultural land using an optical acquisition unit of the agricultural spraying device to obtain image information;
identifying the weeds in the acquired field section using the control unit using the image information in order to assign them to one of two cotyledon classes, the two cotyledon classes including monocotyledons, and dicotyledons;
ascertaining a first weed identification number for the weeds assigned to the monocotyledons and a second weed identification number for the weeds assigned to the dicotyledons, using the control unit; and
applying the at least one spray product applied to the acquired field section of the agricultural land using the at least one spray nozzle unit of the agricultural spraying device depending on:
the cotyledon class of the crop plants, and
the first ascertained weed identification number and/or the second ascertained weed identification number.

15. The method according to claim 14, further comprising:
providing or ascertaining, depending on the cotyledon class of the crop plants a first application threshold value for the first weed identification number and a second application threshold value for the second weed identification number, wherein, in the step of applying, the at least one spray product is applied depending on the first application threshold value and/or the second application threshold value.

16. The method according to claim 15, wherein, in the step of applying, the first weed identification number is compared to the first application threshold value and/or the second weed identification number is compared to the second application threshold value using the control unit, wherein the at least one spray product is applied when the first application threshold value or the second application threshold value, is reached or undershot or exceeded.

17. The method according to claim 15, wherein:
the first application threshold value for the first weed identification number is greater than the second application threshold value for the second weed identification number when the crop plants are assigned to the monocotyledons; and/or
the application threshold value for the second weed identification number is greater than the application threshold value for the first weed identification number when the crop plants are assigned to the dicotyledons.

18. The method according to claim 17, wherein:
the second application threshold value for the second weed identification number is selected such that the at least one spray product or at least one of the at least one spray product is applied when the crop plants are assigned to the monocotyledons and at least one of the identified weeds is assigned to the dicotyledons; and/or
the first application threshold value for the first weed identification number is selected such that the at least one spray product or at least one of the at least one spray product is applied when the crop plants are assigned to the dicotyledons and at least one of the identified weeds is assigned to the monocotyledons.

19. The method according to claim 14, wherein the first and second weed identification numbers represent a number of the respective weeds or a degree of coverage of the acquired field section of plant material of the respective weeds or a quantity of plant material of the respective weeds.

20. The method according to claim 14, wherein, in the step of applying, the control unit is used to ascertain whether and/or how much and/or which of the at least one spray product is applied.

21. The method according to claim 14, wherein, in the step of applying, a first spray product is applied depending on the first ascertained weed identification number and/or a second spray product different from the first is applied depending on the second ascertained weed identification number.

22. The method according to claim 21, wherein the spray products:
are provided premixed in separate spray product tanks of the agricultural spraying device; or
are mixed as needed in the step of applying using a mixing unit of the agricultural spraying device.

23. A control unit configured to carry out and/or control the following steps:
receiving or ascertaining a cotyledon class of crop plants, wherein the crop plants can be assigned to a cotyledon class of monocotyledons or a cotyledon class of dicotyledons;
identifying weeds in image information of a field section of agricultural land acquired using an optical acquisition unit to assign each one of the weeds to a cotyledon class of monocotyledons or a cotyledon class of dicotyledons;
ascertaining a first weed identification number for the weeds assigned to the cotyledon class of monocotyledons and a second weed identification number for the weeds assigned to the cotyledon class of dicotyledons; and
outputting a control signal, in order to apply at least one spray product to the acquired field section of the agricultural land using at least one spray nozzle unit of an agricultural spraying device, depending on:
the cotyledon class of the crop plants, and
the first ascertained weed identification number and/or the second ascertained weed identification number.

24. Agricultural spraying device for applying at least one spray product to agricultural land having crop plants and weeds, comprising:
at least one spray nozzle unit;
at least one optical acquisition unit; and
a control unit configured to carry out and/or control the following steps:
receiving or ascertaining a cotyledon class of crop plants, wherein the crop plants can be assigned to a cotyledon class of monocotyledons or a cotyledon class of dicotyledons;
identifying weeds in image information of a field section of agricultural land acquired using the optical acquisition unit to assign each one of the weeds to a cotyledon class of monocotyledons or a cotyledon class of dicotyledons;
ascertaining a first weed identification number for the weeds assigned to the cotyledon class of monocotyledons and a second weed identification number for the weeds assigned to the cotyledon class of dicotyledons; and
outputting a control signal, in order to apply at least one spray product to the acquired field section of the agricultural land using the at least one spray nozzle unit of the agricultural spraying device, depending on:
the cotyledon class of the crop plants, and
the first ascertained weed identification number and/or the second ascertained weed identification number.

25. A non-transitory machine-readable storage medium on which is stored a computer program for applying at least one spray product to agricultural land having crop plants and weeds, using at least one spray nozzle unit of an agricultural spraying device, wherein the crop plants and the weeds can be assigned to a cotyledon class of monocotyledons or to a cotyledon class of dicotyledons, the computer program, when executed by a computer, causing the computer to perform the following steps:
providing or ascertaining a cotyledon class of the crop plants;
acquiring a field section of the agricultural land using an optical acquisition unit of the agricultural spraying device to obtain image information;
identifying the weeds in the acquired field section using the control unit using the image information in order to assign them to one of two cotyledon classes, the two cotyledon classes including monocotyledons, and dicotyledons;
ascertaining a first weed identification number for the weeds assigned to the monocotyledons and a second weed identification number for the weeds assigned to the dicotyledons, using the control unit; and
applying the at least one spray product applied to the acquired field section of the agricultural land using the at least one spray nozzle unit of the agricultural spraying device depending on:
the cotyledon class of the crop plants, and
the first ascertained weed identification number and/or the second ascertained weed identification number.
